(19) United States
(12) Patent Application Publication
(10) Pub. No.: US 2004/0260703 A1
(43) Pub. Date: Dec. 23, 2004

(54) Quantitative property loss risk model and decision analysis framework

(76) Inventors: Debra A. Elkins, Sterling Heights, MI (US); P. Kyle Weddle, Westland, MI (US)

Correspondence Address: General Motors Corporation, Legal Staff, Mail Code 482-C23-B21, 300 Renaissance Center, P.O. Box 300, Detroit, MI, 48265-3000, US

(21) Appl. No.: 10/600,505

(22) Filed: Jun. 20, 2003

(51) Int. Cl. G06F 17/00

(52) U.S. Cl. 707/100

(57) ABSTRACT

Disclosed is an enterprise risk system which allows improved management of business interruption risks. Business interruption risks are those risks that can significantly disrupt normal business operations and include traditional hazard risks, catastrophes, and natural disasters, as well as many types of supply chain disruptions.

### FIELD OF THE INVENTION

The present invention relates to risk assessment and more particularly to a quantitative methodology to analyze property risks along a manufacturing supply and production stream.

### BACKGROUND OF THE INVENTION

Fundamentally, organizations must evaluate an enterprise's risks by evaluating: What are the most significant risks to this company? How likely are they to occur? What is management doing about them? Traditionally, business operations such as supply chain and manufacturing operations and insurance risk management have not been closely linked. Major insurance coverage reductions and higher premium rates in the global insurance markets have forced insurance risk management groups to consider alternative methods to reduce or control corporate risks, or to go without insurance.

Typically, organizations utilize many methods to evaluate system or process risks to individual elements along a manufacturing or supply chain. As an example, Failure Modes and Effects Analysis (FMEA) is used to evaluate a System, Design or Process in terms of 3 factors that are related to risk: Severity (S), Likelihood of Occurrence (O) and Detection (D). Each factor is rated on a 1 (best) to 10 (worst) scale using standardized rating criteria. The product of S*O*D is known as the Risk Priority Number (RPN), a number between 1 and 1000. This allows the ranking of various failures and their failure modes to determine where design actions need to be taken.

Additionally, organizations utilize various Probability Analysis techniques to determine the likelihood of occurrence of various events. Many of these have evolved into decision making tools that convert everything into some common unit (usually financial), which can be used to compare alternative choices. In general these are called Engineering Risk and Benefits Analysis. Most Engineering Risk and Benefits Analysis techniques involve estimating the likelihood of events, quantifying the risk and benefit of the outcomes, and then calculating the most likely outcome.

Systems dynamics techniques involve modeling a system based upon expected behaviors and the contributors to those behaviors. Systems utilizing this technique vary inputs or relationships and monitor outputs. Systems dynamics can be used to try to understand how a complex system will behave given various assumptions. This methodology is a tool for understanding a system and mitigating risk rather than a tool for quantifying risk. Once a model is defined, however, it is possible to get quantification of specific outcomes.

What is needed however is a system interruption analysis due to the magnitude of losses possible, which evaluates the huge impact such risks can have on current and future organizational strategy. These types of analysis can help organizations to better understand their operational inter-dependencies, proactively identify response options, and plan mitigation responses to a variety of outage scenarios. Organizations that demonstrate and communicate effective risk management practices guard against earnings related surprises.

Currently available risk analysis methodologies, however, do not provide an enterprise level framework for quantifying the subset of business interruption risks. As such, what is needed is a framework that connects probabilistic insurance risk information to a business operations model so that an organization's enterprise risk profile can be explored.

### SUMMARY OF THE INVENTION

Disclosed is a quantitative property loss risk model and decision analysis system. The system provides a rapid and efficient methods to identify and rank property risks. The system further facilitates a quantitative scenario analysis of business interruption impacts. The system helps prioritize risk management, control, and reduction strategies to key property income drivers. Further, the system improves insurance buying and capital allocation for risk management. Net profit cash flow as well as other measures can be used as a probabilistic risk measure so that risk is directly linked to financial business performance.

In one embodiment of the invention, the system provides a modeling framework that can be used to study an organization's business interruption risk. The model measures risk changes by obtaining a probability distribution on contribution margin (net profit). The modeling paradigm can be used for both proactive and reactive risk analysis. Proactively, organizations can explore strategic decisions and investigate risk reduction options. Reactively, risk analysts can play “what-if” analysis and rapidly evaluate different risk mitigation options.

In another embodiment of the invention, the proposed modeling framework allows different managers to examine how their strategic decisions may impact the overall corporate risk profile. For example, supply chain managers can investigate how proposed changes in the supply chain network structure, different suppliers, different logistics routes, or alternative transportation methods, may reduce or increase overall enterprise risk. Additionally, insurance managers can study the probability and possible loss severity of different risks that could significantly disrupt normal business operations. The system then allows the organization to then consider methods to control, mitigate, or transfer the risk.

Organizations can achieve a competitive advantage by improving its management of enterprise risks. Organizations can avoid substantial contribution margin losses by responding rapidly and effectively to different business interruptions, particularly those impacting supply chain material flows.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 represents a business interruption framework according to the teachings of the present invention;

FIG. 2 represents a operational dependency diagram utilizing the system according to FIG. 1;

FIG. 3 represent a stochastic process applied by the system; and

FIG. 4 represents a flowchart of the risk model process according to the teachings of the present invention.

### DETAILED DESCRIPTION OF THE PREFERRED EMBODIMENTS

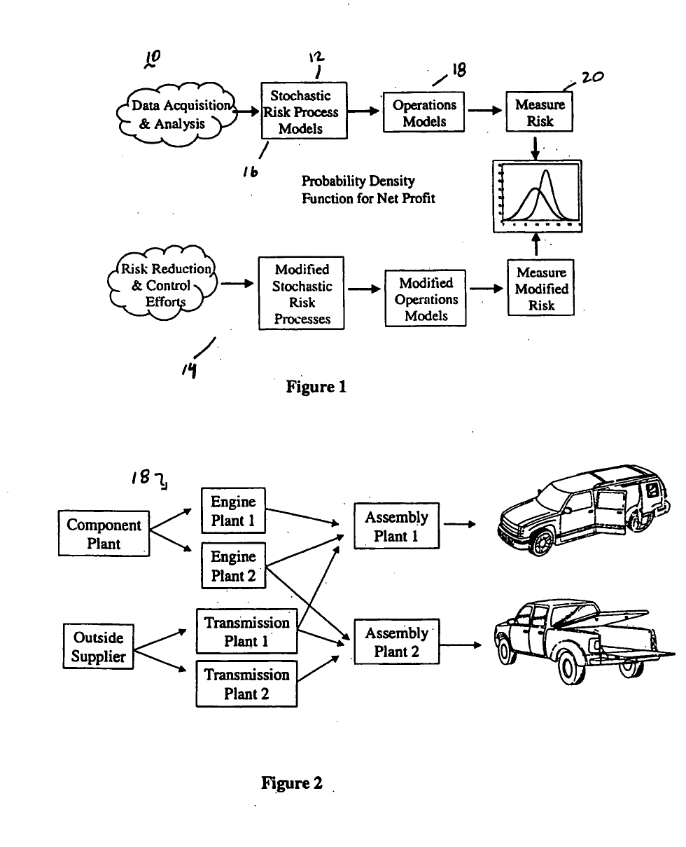

FIG. 1 represents a quantitative property loss system 10 according to the teachings of the present invention. The quantitative property loss system 10 proposed is a high level model that connects probabilistic risk modeling to business operations interdependencies. The system 10 is adapted to assess and rank business interruption risks in industries such as the automotive, semi-conductor, consumer electronics, aerospace, or military sectors. A resulting risk profile (i.e., probability distribution) of net profit ties risk management and other operational activities directly to business performance by measuring the cash flow impacts of various organization interrupting events. The system 10 provides a quantitative property loss risk model 12 and decision analysis framework 14 to provide a quick and efficient method to identify and obtain consistent property risk analysis to any organization's assets. Having such a quantitative methodology relieves computational burden on quarterly property loss analysis and allows organizations to prioritize risk management, control, and reduction strategies to key property assets.

The system 10 provides the general framework 14 that can be used to quantitatively assess business interruption risks proactively and reactively. The system 10 combines probabilistic risk information with business operations models to aid decision makers in evaluating options to manage many of the risks in the enterprise portfolio. The system 10 additionally provides a platform to perform detailed “what-if” analysis for both proactive risk assessment, and reactive risk mitigation. Proactively, the system 10 allows for an exploration of strategic decisions and identification of risk control or reduction options for organizations to consider. Reactively, the system 10 provides tools to quickly assess the impact of an event, and to help organizations with identifying and evaluating mitigation alternatives.

The system 10 provides a framework to benchmark the current corporate risk profile using the top half of the framework specified in FIG. 1, and compare it to the modified risk profile, using the bottom half. Simple deterministic analysis or Monte Carlo simulation can be used for initial impact analysis.

The business interruption framework 14 has three key elements. The first element 16 involves developing appropriate risk process models based on statistical data (if available), information, and expert opinion. While the system disclosed is based upon the use of stochastic risk process models, it is envisioned that any risk analysis model can be used. Optionally, the risk process models can calculate event occurrence probabilities and conditional property damage loss distributions. Losses from risk event occurrences may depend on location and sequential timing of events; these factors should also be considered in the probabilistic risk assessment.

The second element 18 of the system includes operations models that capture the interconnected nature of the enterprise. It is envisioned that the operations models may include business process relations, global value chains, or supply chain maps. Different business flows (e.g., information, knowledge, cash, raw material, and capital equipment) may also need to be modeled in the operations models to enable impact assessments for different types of disruptions.

The third element 20 requires devising appropriate metrics for business interruption risks. One such measure that should be used is a risk probability distribution of net profit. This measure is useful, because many organizational decisions ultimately are financial decisions. The word “measure” specifically emphasizes the probability measure context.

FIG. 2 represents an operational dependency diagram utilizing the system 10 according to FIG. 1. The system 10 begins with a very broad, cross-functional perspective of an organization. The system evaluates a portfolio of enterprise risks by systematically identifying, quantifying, and managing all risks and opportunities that can affect achievement of a corporation's strategic and financial objectives. Generally, the portfolio of enterprise risks are divided into four major risk areas: Financial risks—such as interest rate and exchange rate fluctuations; debt and credit issues; Strategic risks—such as market share battles, joint venture decisions, product development cycles, budget overruns, new competitors, demand variability, product-market alignment issues; Hazard risks—such as natural disasters and catastrophes such as storms, earthquakes, lightning strikes; Operational risks—such as supply chain, business process, or IT system failures such as computer or telecommunications networks failures, the loss of key personnel or suppliers, or utility failures. A further list of risks can be found in an evaluation of the airline industry is described by Michael Zea, “Is Airline Industry Risk Unmanageable?” Mercer on Transport & Travel, Fall 2002/Winter 2003, Volume IX, Number 2, pp. 21-26.

Additionally, the risk portfolio is also divided into risks that are internally or externally driven. Note that some risks can be influenced by internal actions but, generally, most risks are externally driven. The risk portfolio can easily be modified for semi-conductor, consumer electronics, aerospace, or defense sector industries allowing for the cross industry application of the invention. Institutions may have some risks that are location dependent and industry specific, but many of the hazard and operational risks are common across industries.

Institutional interruption risks are those that significantly disrupt normal business operations. Most institutional interruption risks fall into the hazard and operational risk categories in the portfolio of enterprise risks. Note that global supply chain disruptions impacting material or information flows are but one type of business interruption risk. Other business interruption risks include events such as catastrophic plant fires, weather-related risks, political border closures, IT infrastructure attacks (i.e., computer viruses), or supplier failures (quality problems, logistics problems, supplier's own business interruptions).

In order to assess business interruption risks objectively, different types of quantitative models are desired. These models must permit probabilistic analysis of multiple types of risks and handle dependency between risks. The models must also capture the risks inherent in the dependent network structure of business operations, where the financial impact of a business interruption event is felt. Graphical and mathematical analysis of network connectivity and interdependence is a key need, particularly for business operations or supply chain redesign. Further, the analysis tools should help with identifying and evaluating risk reduction options, and make risk cost-benefit analysis easier to perform.

Probabilistic models are then built by combining available information and expert opinion. While the non-repeatable risk models are more subjective, the models are better than not using available information. Once the subset of business interruption risk events has been identified and selected from the industry portfolio of risks, the list is further divided into repeatable and non-repeatable risks for stochastic risk process modeling and analysis. The two groups are distinguished by how much past statistical data is available for probabilistic modeling.

Within the risk portfolio, repeatable risks are those that can be modeled using statistical distribution fitting, when there is plenty of past statistical data relevant to the problem. The key modeling assumption being made for repeatable risks is that past risk experience and exposure is similar to future risk experience and exposure. Statistical models then allow an organization to predict the likelihood of occurrence and potential loss amount to be experienced per future event. In comparison, non-repeatable risks are those that cannot be modeled directly using statistical approaches, because little or no raw data exists, or the data is quite expensive or difficult to gather.

The goal of preliminary risk modeling is to develop a 2-dimensional frequency versus severity risk classification map. In theory, each business interruption risk can be plotted on the map with its Cartesian coordinates being the frequency of occurrence (or probability of occurrence) and expected loss severity, given that the event occurs. In practice, data acquisition to assess frequency and severity of each risk may prove very challenging. Subjective estimates based on expert opinion of frequency versus severity can suffice for initial risk prioritization and classification. Organizations can use these maps to sort the risks, decide whether to insure or finance each risk, and plan how much money to allocate for managing each risk.

The risk map prioritizes management focus to a set of risks having high frequency of occurrence and high loss potential. Organizations can now examine methods to reduce the frequency or mitigate the loss severity for these risks. However, the risk reduction achieved may not be worth the money spent to achieve the reduction. In this case, an organization may have to tolerate the risk (but is now explicitly aware of the risk), or look to transfer the risk through insurance or other means.

Next, the system 10 allows organizations to address risks having low frequency but high potential loss severity, as is the case with many rare but insurable risk events, and risks having high frequency of occurrence and low to medium loss severity. These risks are ideal for risk financing. Risks having the lowest priority are those having both low frequency of occurrence, and low loss severity are the least important to spend money on.

The next step in probabilistic risk analysis is to improve models of business interruption risks based on the priority order as defined by the two dimensional risk map. Enhanced stochastic process models of risks build better knowledge about the behavior of different risks, and allow examination of the effects of interaction between different risks. Better modeling and understanding of risks is a key component of the business interruption framework.

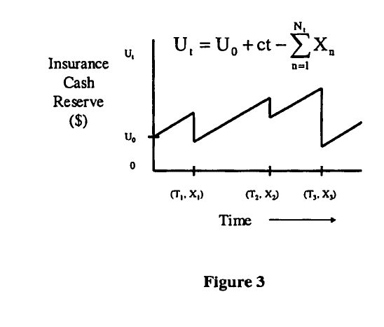

An example of a stochastic process applied by the system is shown in FIG. 3. The process shows that there are institutional risks that occurs at different points in time. Each time the risk event occurs, there is an associated loss. An insurance company starts an insurance fund with some initial investment U₀. Insurance premiums (payment for insurance coverage from different customers) are accrued linearly over time. Customers file claims for insurance coverage when a risk event and damage occurs. The insurance company then pays out a claim from the insurance surplus process to cover against the customer's insured loss. From the insurance company's perspective, the company would like to know what the probability is that the fund never “ruins” or goes bankrupt.

Mathematically, the insurance surplus fund stochastic process as follows. Let Tₙ be the time of n^{th} risk event occurrence, Xₙ be the financial loss associated with n^{th} risk event, and Nₜ be the number of risk events that occur in the time period (0, t]. Define the insurance fund surplus process Uₜ by

$${U}_{t} = {U}_{0} + ct - {\sum }_{n = 1}^{{N}_{t}} {X}_{n} ,$$

where Uₜ is the insurance surplus fund value at time t, U₀ is the initial investment, and c is the linear premium accrual rate. Note that the summation term adds up the cumulative losses from risk events occurring in [0, t].

The “survival probability,” or the probability that the insurance fund never ruins can then be expressed by P{Uₜ≧0,∀t≧0}. If the probability distribution for time between risk events and the probability distribution for loss per risk event is known, the survival probability can be evaluated (at least in theory) by solving a stochastic integral equation. The computational details of the stochastic integral equation are beyond the scope of this paper, and further details are omitted. It suffices to say that the survival probability (i.e., “non-ruin probability”) can be computed, and it depends on the initial investment U₀ and the premium accrual rate c.

Classical risk models generally assume there is but one type of repeatable risk event, and that risk events occur independently. Further, the sequence of losses observed are independent, and are also independent of the sequence of times when the risk events occur. In reality, correlated risks and losses are not uncommon, and can cause widely differing results from classical risk models. For example, an earthquake often has a period of aftershocks, which are clearly correlated to the original earthquake. These operational interdependencies, such as a supplier providing the same part to multiple assembly plants, can cause significant supply chain disruption risk. Thus the mathematical models are not very intuitive for assessing business interruption risk from a supply chain perspective.

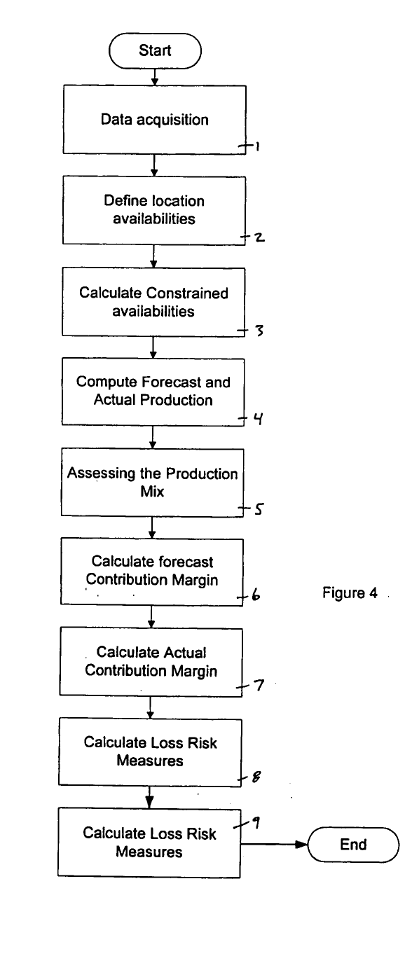

FIG. 4 represents a flow chart describing the system 10 according to the teachings of the present invention. As depicted in the flow chart is a series of steps which when used in conjunction allows an organization to produce a reliable risk calculation model.

Beginning with process block 1, data is acquired with respect to the manufacturing system. In the case of a manufacturing supply chain, nodes in the system can represent manufacturing sites either inside or outside an organization. Additionally, the nodes can represent transportation and logistics links in the supply chain such as rail lines or ports of entry for components. The links can also represent infrastructure connections such as utility lines, water lines, or telecommunications lines. In process block 2, location availabilities for manufacturing are calculated. At this point, excess capacity is evaluated. In this regard, the carrying cost of excess capacity may be evaluated in the calculation of the costs to mitigate risks by the purchasing of insurance or by using multiple component suppliers.

In process block 3 constrained availabilities due to production limitations are calculated. In process block 4 forecasted and actual production of components is calculated. In process block 5 the production mix for a production facility is assessed. In process block 6, the forecast contribution margin for all of the assembly plants is calculated. In process block 7, the actual contribution margin for each assembly plant under a business interruption loss scenario with no business resumption or mitigation efforts is calculated. In process block 8, an evaluation is conducted as to proper loss risks measures; for example contribution margin lost; total vehicles lost; and total number of sites impacted. In process block 9, property locations are rated based on different measures.

Returning to FIG. 2, the model identifies and quantitatively measures business interruption risks for different property locations to prioritize loss control spending and risk reduction activities. The risks that the system is concerned with involve risks from undesirable events including, but not limited to hazard and operational risks from a property and casualty insurance perspective (or actual disasters, catastrophes, supply chain interruptions, etc.). Specifically, the system according to teaching the presence of mention, considers risks to physical property assets.

The system 10 first ranks property loss locations. The system 10 then ranks property loss based on dollars or on a subjective factor. The system 10 then calculates a contribution margin based on dollars and on a subjective term. The system 10 then calculates actual contribution margin. Additionally, the system 10 incorporates mitigation into the planning. As an example, the system 10 calculates which facilities must be hardened to reduce risk. The system 10 calculates the proper amount of insurance to be purchased either with or without mitigation. The system 10 analyzes the unused plant capacity in determining the possibility of mitigation factors.

In developing the business interruption framework 14, it has proved useful to have a simple supply chain “map” (such as in FIG. 2) to illustrate the impact of different business interruption risk events on production operations. This provides a tool which allows organizations to conduct a “what-if” scenario analysis to visualize and quantify the downstream impact if an engine plant or a key supplier is lost. Note that to assess the financial impact of a disruption, the value of lost production must be measured. Financial loss or risk impact also depends on the outage duration and the ability to mitigate the production outage for the particular risk event. The financial impact of lost production is often significantly more than the actual property damage or the mitigation cost resulting from the risk event, particularly in the automotive, semi-conductor, and consumer electronics industries.

A second advantage of this simple map is that it helps different business units understand the importance of business continuity or resumption planning. This map style has proved extremely valuable in engaging executives in discussions about enterprise risks, and facilitates creative planning and consideration of mitigation alternatives. These discussions often lead to functional units actively including risk in future strategic and tactical decisions.

There are two key areas of supply chain management that can be extended to enhance operational models for business interruption risk assessment. The first area is the more classical supply chain optimization modeling and supplier management research. The second area is supply chain vulnerability research.

The system 10 envisions utilizing applied probability, insurance risk financing, supply chain management, and decision analysis, and extending the results of the system. One distinct area of improvement is enterprise risk management in supplier-OEM relationships. The system allows an organization to manage supplier risks via a portfolio of supplier contracts. The systems allows organizations to discuss and evaluate risk sharing, risk transfer mechanisms, and options for dynamic risk hedging. Effective risk management may turn out to be an additional core competency that suppliers can offer in bidding for contracts.

The cost of risk management needs to be included in global sourcing decisions, particularly for critical components required in high volume, having a long production lead-time, utilizing a specialized production process, or produced by only a few suppliers. There also has been significant industry discussion on how to monitor “supplier health” for proactive risk management and on supplier evaluation for sourcing decisions. Typically, some risk indicators may be monitored including financial performance, delivery reliability, and quality metrics, especially for “troubled suppliers.” Automated monitoring systems and exception based management techniques may improve early detection of unfolding supplier problems, giving the OEM more time to plan and respond.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for evaluating an organizations institutional risk comprising the steps of:
a) acquiring data with respect to a manufacturing system;
b) calculating location availabilities for manufacturing;
c) calculating constrained availabilities due to production limitations;
d) calculating forecasted and actual production of components;
e) assessing the production mix for a production facility;
f) calculating, the forecast contribution margin for all of the assembly plants is calculated;
g) calculating the actual contribution margin for each assembly plant under a business interruption loss; and
h) conducting an evaluation as to proper loss risks measures.

2. The method according to claim 1 wherein acquiring data is acquiring data on one of a manufacturing site inside the organization, a manufacturing site outside the organization.

3. The method according to claim 1 wherein acquiring data is acquiring data from one of a rail line or port of entry for components.

4. The method according to claim 1 wherein calculating location availabilities for manufacturing is calculating excess capacity.

5. The method according to claim 1 wherein calculating location availabilities for manufacturing is calculating the carrying cost of excess capacity.

6. The method according to claim 1 wherein calculating location availabilities for manufacturing is one of calculating the cost to mitigate risks by the purchasing of insurance and calculating the cost to mitigate risks by using multiple component suppliers.

7. The method according to claim 1 wherein calculating actual contribution margin for each assembly plant is one of calculating actual contribution margin for each assembly plant with no business resumption or calculating actual contribution margin for each assembly plant with no mitigation effort.

8. The method according to claim 1 wherein conducting an evaluation as to proper loss risks measures is conducting an evaluation as to one of contribution margin lost, total vehicles lost, and total number of sites impacted.

9. The method according to claim 1 further including the step of:
i) rating property locations based on the a proper loss risks measures.

10. A quantitative property loss risk model and decision framework for use to study an organization's business interruption risk, the quantitative property loss risk model and decision framework comprising:
a risk process model;
an operations model that captures the interconnected nature of the enterprise; and
metrics for business interruption risks, wherein the risk process model measures risk changes by obtaining a probability distribution on contribution margin.

11. The system according to claim 10 wherein the risk process model is based on one of statistical data, information, and expert opinion.

12. The system according to claim 10 wherein the risk process model includes a subroutine which functions to provide one of proactive and reactive risk analysis.

13. The system according to claim 12 wherein the subroutine is configured to investigate proactive risk reduction options.

14. The system according to claim 12 wherein the subroutine is configured to investigate reactive risk reduction options.

15. The system according to claim 12 wherein the subroutine is configured to conduct “what-if” analysis.

16. The system according to claim 12 wherein the subroutine is configured to evaluate how strategic decisions may impact the overall corporate risk profile.

17. A method for evaluating an organization's enterprise risk comprising the steps of:
a) evaluating an organization's structure;
b) evaluating a contribution margin element within an organization; and
c) evaluating the effect on the organization of at least one event to an element within the organization.

18. The method according to claim 17 wherein evaluating an organization is evaluating an organization's manufacturing stream.

19. The method according to claim 17 further comprising the step of purchasing sufficient insurance to cover losses caused by a given risk.

20. The method according to claim 17 further comprising the step of taking steps to reduce threats to contribution margin.

21. The method according to claim 1 further comprising the step of conducting an stochastic risk analysis.
